(19) United States
(12) Patent Application Publication
(10) Pub. No.: US 2022/0066835 A1
(43) Pub. Date: Mar. 3, 2022

(54) CONTROLLING NETWORK RESOURCE ALLOCATION

(71) Applicant: International Business Machines Corporation, Armonk, NY (US)

(72) Inventors: Evgeny Shindin, Nesher (IL); Michael Masin, Haifa (IL); Alexander Zadorojniy, Haifa (IL)

(21) Appl. No.: 17/006,988

(22) Filed: Aug. 31, 2020

(51) Int. Cl. G06F 9/50; H04L 12/911

(52) U.S. Cl. CPC G06F 9/5038; H04L 47/82; G06F 9/5083

(57) ABSTRACT

In an approach, a processor stores a dictionary set, including simplex dictionaries, for saving processing time when calculating an optimal control policy for at least one linearly time dependent value function of a plurality of variables complying with a plurality of linearly time dependent constraints. A processor calculates a storage limit for the dictionary set, based on a number of the plurality of variables, the plurality of constraints, and size of a memory. A processor removes at least one of the plurality of simplex dictionaries in accordance with the storage limit, while maintaining a neighbor density measure, where the neighbor density measure is based on a distance between the at least one of the simplex dictionaries and a non-removed simplex dictionary and the distance corresponds to a number of simplex pivots required to construct the at least one of the simplex dictionaries from the non-removed simplex dictionary.

### STATEMENT REGARDING OTHER (NON-US) SPONSORED WORK

The project leading to this application has received funding from the European Union's Horizon 2020 research and innovation programme under grant agreement No 732105.

### STATEMENT REGARDING PRIOR DISCLOSURES BY THE INVENTOR OR A JOINT INVENTOR

The following disclosure(s) are submitted under 35 U.S.C. 102(b)(1)(A):

(i) Evgeny Shindin, “saving some results”, May 26, 2020, GitHub, <https://github .com/IBM/SCLPsolver/commit/1d19b7032d3d8f61ac19d85dc4da4f38819c0f8f>: and

(ii) Evgeny Shindin, “deleting binary”, May 26, 2020, GitHub, <https://github.com/IBM/SCLPsolver/commit/e03bd1f684c9a73c1a80c575aaf8188b0c25c07f>.

### BACKGROUND

The present invention, in some embodiments thereof, relates to continuous linear programming, and, more particularly, but not exclusively, efficient use of computer memory and processors for optimizing network flow.

There are several algorithms to solve continuous linear programming problems. These algorithms are used for optimization of network data flow, resource allocation, and/or the like, in addition to flow of actual fluids in chemical factories, urban infrastructure such as water pipes, and/or the likes. Many ubiquitous linear programming algorithms are based on a simplex type algorithm.

Problems that may be solved using simplex type algorithms include separated continuous linear programming (SCLP), measure-based continuous linear programming (MCLP), fractional continuous linear programming, variations such as rolling horizon, complementary problems, and the likes. The optimal solution for separated continuous linear programming, where constraints and optimization goals may be linearly time dependent, is piecewise linear. The solution may comprise piecewise linear functions, and may be described by a list of boundaries and a family of N linear programming (LP) problems with the same parameters, but different sign restrictions, known as Rates-LP. To each linear segment of the piecewise linear solution corresponds different set of the sign restrictions of the Rates-LP and set of the indexes of the basic variables of the optimal solution of this Rates-LP forms basis. Thus, linear segments of the piecewise linear solution may be referred to as bases, and a single segment may be referred to as a linear segment, a segment a base, or a basis. The solutions for adjacent Rates-LP problems may differ by one simplex pivot. A sequence of consecutive bases of Rates-LP is known as a bases-sequence. Simplex-type algorithm may solve SCLP parametrically for a variety of time horizons, starting from θ=0 and producing an optimal solution for a desired time horizon at the end θ=T. The Simplex-type algorithm may continue finding an optimal and valid solution for a farther time horizon, and during this process, one or more variables may reach zero, giving rise to a collision. The variables reaching zero may be referred to as collision variables. The collision indicates that current optimal base-sequence may not be optimal for farther time horizons, and therefore a new base sequence should be calculated. Procedure of calculation of new base-sequence is known as SCLP pivot, MCLP pivot, and/or the likes. During pivots such as SCLP pivot, some bases may be removed, added or replaced at specific points of the base sequence, which are determined by the collision variables.

### SUMMARY

According to a first aspect of some embodiments of the present invention there is provided a system for generating optimal control policy for controlling network resource allocation, including one or more computer processors, one or more computer readable storage media, and program instructions collectively stored on the one or more computer readable storage media for execution by at least one of the one or more computer processors. The program instructions include program instructions to store a dictionary set, comprising simplex dictionaries, for saving processing time when calculating an optimal control policy for at least one linearly time dependent value function of a plurality of variables complying with a plurality of linearly time dependent constraints. The program instructions also include program instructions to calculate a storage limit for the dictionary set, based on numbers of the plurality of variables, the plurality of constraints, and size of a memory. The program instructions also include program instructions to remove at least one of the plurality of simplex dictionaries from the dictionary set in accordance with the storage limit, while maintaining a neighbor density measure, where the neighbor density measure is based on a distance between the at least one of the plurality of simplex dictionaries and at least one non-removed simplex dictionary, and the distance corresponds to a number of simplex pivots required to construct the at least one of the plurality of simplex dictionaries from the at least one non-removed simplex dictionary.

According to a second aspect of some embodiments of the present invention there is provided a computer implemented method for generating optimal control policy for controlling network resource allocation, that includes storing a dictionary set, comprising simplex dictionaries, for saving processing time when calculating an optimal control policy for at least one linearly time dependent value function of a plurality of variables complying with a plurality of linearly time dependent constraints. A processor calculates a storage limit for the dictionary set, based on a number of the plurality of variables, the plurality of constraints, and size of a memory. A processor removes at least one of the plurality of simplex dictionaries from the dictionary set in accordance with the storage limit, while maintaining a neighbor density measure, where the neighbor density measure is based on a distance between the at least one of the plurality of simplex dictionaries and at least one non-removed simplex dictionary, and the distance corresponds to a number of simplex pivots required to construct the at least one of the plurality of simplex dictionaries from the at least one non-removed simplex dictionary.

According to a third aspect of some embodiments of the present invention there is provided a computer program product for generating optimal control policy for controlling network resource allocation, including one or more computer readable storage media, and program instructions collectively stored on the one or more computer readable storage media. The program instructions include program instructions to store a dictionary set, comprising simplex dictionaries, for saving processing time when calculating an optimal control policy for at least one linearly time dependent value function of a plurality of variables complying with a plurality of linearly time dependent constraints. The program instructions also include program instructions to calculate a storage limit for the dictionary set, based on numbers of the plurality of variables, the plurality of constraints, and size of a memory. The program instructions also include program instructions to remove at least one of the plurality of simplex dictionaries from the dictionary set in accordance with the storage limit, while maintaining a neighbor density measure, where the neighbor density measure is based on a distance between the at least one of the plurality of simplex dictionaries and at least one non-removed simplex dictionary, and the distance corresponds to a number of simplex pivots required to construct the at least one of the plurality of simplex dictionaries from the at least one non-removed simplex dictionary.

Optionally, the memory further stores a sequence of linear segments, and the neighbor density measure is based on a linear distance between linear segments in the sequence.

Optionally, receiving a time interval for the at least one linearly time dependent value function of a plurality of variables and the plurality of linearly time dependent constraints on the plurality of variables determining a linear segment for the time interval and searching the dictionary set for at least one simplex dictionary based on the proximity between at least one of the linear segments corresponding to the time interval and the linear segment corresponding to simplex dictionary.

Optionally, responsive to the at least one simplex dictionary complying with the corresponding time interval, using the at least one simplex dictionary for calculation of at least one linear segment associated with the time interval.

Optionally, responsive to the at least one simplex dictionary mismatching the time interval by at least one index, calculating a new simplex dictionary that matches the time interval by applying at least one simplex type pivot on the at least one dictionary.

Optionally, allocating at least one network resource in accordance with the sequence of linear segments for at least one variable from the plurality of variables, wherein the at least one variable is associated with the at least one network resource.

Optionally, at least one variable from the plurality of variables is associated with at least one network resource, and the at least one linearly time dependent value function is correlated to at least one performance index of the at least one network resource.

Optionally, the at least one network resource comprises a pipe used for transporting at least one fluid.

Optionally, wherein the at least one network resource comprises at least one communication device on a computer network.

Optionally, wherein the at least one network resource comprises at least one processor on a computer network.

Optionally, the at least one of the plurality of simplex dictionaries in the dictionary set is derived from a simplex type algorithm.

Optionally, calculating a storage limit for the dictionary set is based on the numbers of the plurality of variables and the plurality of linearly time dependent constraints.

Optionally, the at least one simplex dictionary is added dictionary to the dictionary set is the corresponding simplex dictionary of a linear segment being added to the sequence of linear segments.

Optionally, responsive to a linear segment being removed from the sequence of linear segments, removing the corresponding simplex dictionary from dictionary set.

### BRIEF DESCRIPTION OF THE DRAWINGS

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a schematic illustration of an exemplary system for network flow optimization using a simplex type algorithm, according to some embodiments of the present disclosure;

FIG. 2 is a flowchart of an exemplary process for network flow optimization using a simplex type algorithm, according to some embodiments of the present disclosure;

FIG. 3A depicts an exemplary base sequence with the corresponding dictionary set, before removing dictionaries in accordance with the storage limit, according to some embodiments of the present disclosure;

FIG. 3B depicts an exemplary base sequence with the corresponding dictionary set, after removing dictionaries in accordance with the storage limit, while maintaining a neighbor density measure, according to some embodiments of the present disclosure;

FIG. 3C depicts an exemplary base sequence with the corresponding dictionary set, after removing dictionaries in accordance with the storage limit, while maintaining a neighbor density measure, according to some embodiments of the present disclosure;

FIG. 3D depicts an exemplary base sequence interval progression, as time horizon is extended, according to some embodiments of the present disclosure;

FIG. 4A depicts an exemplary solution space, based on a truncated simplex and having a dictionary set associated with, projected to two dimensions, according to some embodiments of the present disclosure;

FIG. 4B depicts an exemplary sequence of simplex pivots over a solution space, based on a truncated simplex, projected to two dimensions, according to some embodiments of the present disclosure;

FIG. 5A is an exemplary formulation of separated continuous linear programming (SCLP) problems, according to some embodiments of the present disclosure;

FIG. 5B is a formulation of an exemplary measure-based continuous linear programming (MCLP) problem, according to some embodiments of the present disclosure;

FIG. 6 is a solution of the exemplary measure-based continuous linear programming (MCLP) problem, formulated on FIG. 5B, according to some embodiments of the present disclosure;

FIG. 7 is an exemplary code for optimizing a network flow, using a simplex type algorithm, without using simplex dictionaries, according to some embodiments of the present disclosure; and

FIG. 8 is an exemplary code for optimizing a network flow, using a simplex type algorithm, using simplex dictionaries, according to some embodiments of the present disclosure.

### DETAILED DESCRIPTION

Embodiments of the present invention, in some embodiments thereof, relates to continuous linear programming, and, more particularly, but not exclusively, efficient use of computer memory and processors for optimizing network flow.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

As used herein, the terms “linear” and “linearly” refer to problems and functions that may be solved, processed and/or the likes by linear programming, comprising strictly linear functions in a form such as y=ax+b, wherein a, b, x and y may be scalars, vectors, matrices, or tensors, functions that may be projected to linearity, functions for which a linear approximation is practically interchangeable for a significant segment, problems for which a simplex type algorithms may be developed in the future, and the likes.

A process of solving a linear programming network control problem, using a simplex-type algorithm, by increasing the time horizons, starting from θ=0 and ending at θ=T, may encounter collisions, as one or more variables may reach zero at various values of the temporary time horizon θ.

When a collision is encountered, the calculation of the following solution, which may comprise new linear segments, also referred to as bases, which should be added to the tentative solution, also referred to as base-sequence, and/or bases that should be removed from the current base-sequence. The calculations required for collision may be accelerated by using a matching simplex-dictionary.

The simplex dictionary, also referred to as dictionary, may be associated with one or more bases of current bases-sequence, from which the calculation of new bases may start. The simplex dictionaries in the dictionary set may comprise a simplex table, vectors, labels, metadata, functionally interchangeable representations of simplex tables, and/or the likes, and may be derived from a simplex type algorithm. Calculation of new basis requires a number of simplex pivot operations. The number of simplex pivot operations to be performed may depend on position of known simplex dictionary in the bases-sequence and position of collision. Alternatively, simplex dictionaries may be associated with vertices or other points in the solution space, and the number of simplex pivot operation may depend on the boundary structure, the variables imposing tight constraints, and other measures associated the solution space. Since simplex pivot operation may consume a significant amount of processing time, which may increase rapidly as the number of variables and base sequence length increases, storage of a simplex dictionary for all bases in the base sequence may improve the system performance. However, the storage requirement of the single simplex dictionary is characterized by quadratic growth, and the number of dictionaries may further increase as problem complexity increases. Therefore, the dictionary set storage requires significant amount of RAM, and it may be impractical to store all the simplex dictionaries in RAM.

Known methods are either limited in scale or require a large number of simplex pivots to continue after collisions, and that may limit their ability to find the optimal solution in the desired amount of time, incurring usage of suboptimal solutions, that may not provide efficient routing, lead to allocation delays, and thus suboptimal use of distributed resources, network resources, and/or the like.

The problem is how to implement a dictionary set, with high probability of comprising a matching, or a near matching dictionary, while complying with memory constraints. Implementations may be subject to a memory versus speed tradeoff, since storing few dictionaries may provide a limited speed advantage, and storing all dictionaries generated, may require an impractically large storage space. The implementation may check how much random memory (RAM) is available, or allocated by the operating system, for storage of simplex dictionaries. Followingly, the embodiments may store simplex tables, sequences of simplex pivots, vectors, and/or the like, that may be used for calculating one dictionary from other dictionaries. When occupancy of the RAM allocated to store simplex dictionaries exceeds a threshold, embodiments may execute pruning, by removing one or more dictionaries from the stored dictionaries. The removed dictionaries may be chosen in accordance with one or more coverage conserving methods for preservation of a neighbor density measure. Coverage conserving methods may take into account factors including: distance measures from other stored dictionaries, how recently the dictionary was used for an SCLP pivot operation, how many times the dictionary was used for SCLP pivot operations, and randomness.

The advantage of this dictionary policy is that a stored dictionary may have a high likelihood to be a dictionary that comprises the solution for SCLP pivot operation, saving CPU time, power, and the likes. Furthermore, when the simplex dictionary that comprises the solution for SCLP pivot was removed, proposed method may restore this dictionary from other dictionaries that are close enough to required dictionary, so the calculation of required dictionary may be performed with a small number of simplex pivots.

Some preferred embodiments are designed to minimize the number of simplex pivots executed to calculate simplex dictionary required for SCLP pivot operation. This may be achieved by an effective choice of the coverage conserving method.

Some embodiments of the present invention may be used to improve the performance of a computer, used for optimizing processing and routing resource usage on a computation network, communication network, and/or the likes. Other embodiments of the present invention may be used on computer devices, used for control fluid delivery system such as urban water pipe network, gas on a power plant, and/or the likes.

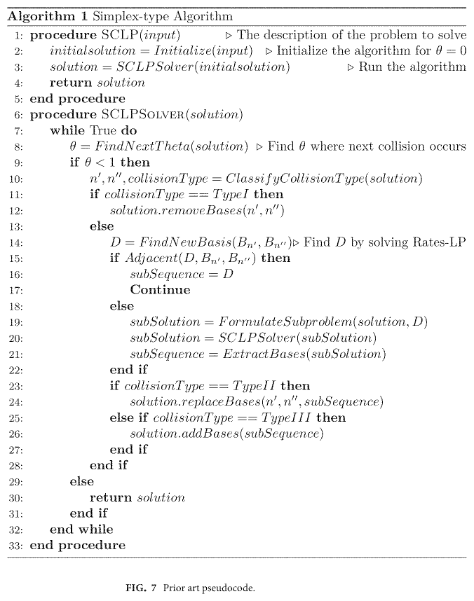

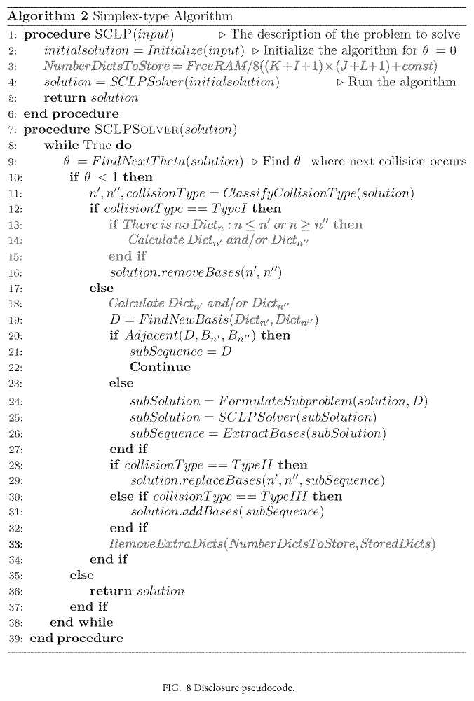

For purposes of better understanding some embodiments of the present invention, as illustrated in FIG. 8 of the drawings, reference is first made to the operation of a code as illustrated in FIG. 7.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

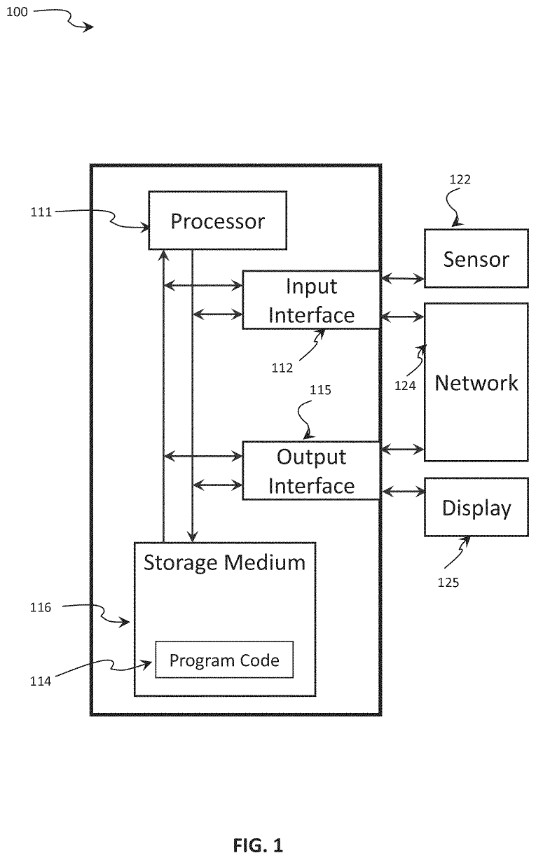

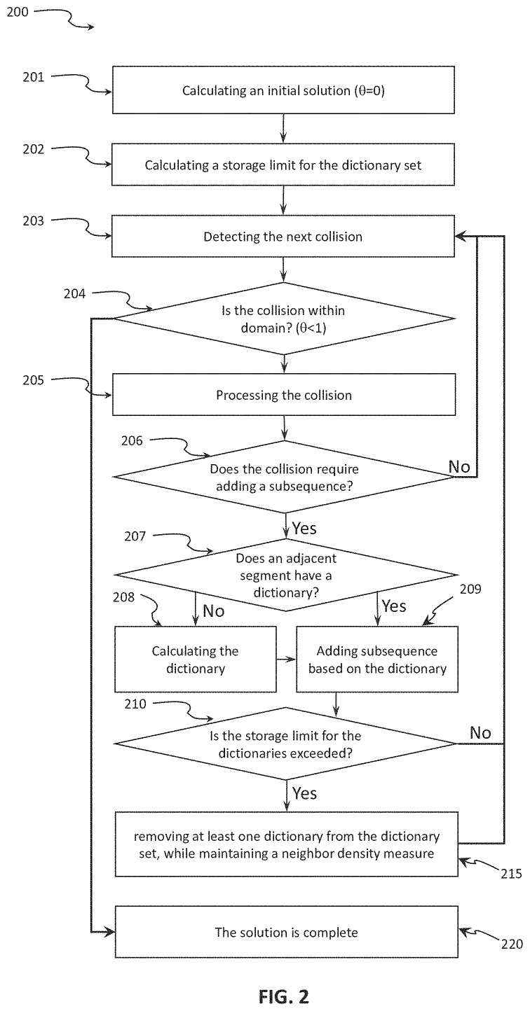

Referring now to the drawings, FIG. 1 is a schematic illustration of an exemplary system for network flow optimization using a simplex type algorithm, according to some embodiments of the present disclosure. An exemplary network flow optimization system 100 may execute processes, such as processes 200, which is described in FIG. 2, and may be applied to optimize flow in a variety of networks, such as communication networks, compute-server networks, electricity networks, pipe networks for oil, water infrastructure, transportation, and/or the like.

The network flow optimization system 100 may include an input interface 112, an output interface 115, a processor 111, and a storage medium 116 for storing a program code 114 and/or data. The processor 111 may execute program code 114 for implementing process 200, which is described in FIG. 2. The network flow optimization system 100 may be implemented on one or more computers, compute server, and or the likes, physically located on a site, and/or implemented, as a distributed system, virtually on a cloud service, on machines also used for other functions, and/or by several other options.

Alternatively, the system 100 may be implemented on a mobile device, a programmable cellular phone, a tablet, and/or the likes.

Further alternatively, the system may comprise dedicated hardware, ASIC, FPGA, and/or the likes. It should be noted that application-specific hardware may account for better speed and lower power consumption, however, at a potential cost of additional resources required during design and limit flexibility in system updates. Hardware with strong parallel processing capabilities, such as one or more single instruction multiple data (SIMD) processors, digital signal processing (DSP) hardware, graphics processing unit (GPU), tensor processing unit (TPU), and/or the likes may be used to improve speed and accuracy, by executing parallel processing on large simplex tables.

The input interface 112 and the output interface 115 may comprise one or more wired and/or wireless network interfaces for connecting to one or more networks, for example, a local area network (LAN), a wide area network (WAN), a metropolitan area network, a cellular network, the interne and/or the like. The input interface 112 and the output interface 115 may further include one or more wired and/or wireless interconnection interfaces, for example, a universal serial bus (USB) interface, a wireless local area network (WLAN), and/or the like. Furthermore, the output interface 115 may include one or more wireless interfaces for loudspeakers, display, updating of external systems such as recommender systems, and/or the like, as well as other processors executing post-processing. The input interface 112 may include one or more wireless interfaces for receiving information from one or more devices. Additionally, the input interface 112 may include specific means for communication with one or more sensors 122 such as a camera, microphone, keyboard, touchscreen, mouse, scanner and/or the like. The sensor 122 may also be used to update configuration, preferences, and/or the like. The input interface may be configured to access the network 124, in order to receive indicators about the states of network elements, such as queue length, resource usage, fault indications, fluid pressure and the like. The network 124 may be accessed for allocating network resources in accordance with the variables in the solution sequence, which are associated with the corresponding network resources. This may be done by controlling queue priorities, taps, relays, and the likes. Similarly, the output interface 115 may include specific means for communication with one or more displays 125 such as a loudspeaker, screen, projector and/or the like. Furthermore, the display device may comprise a model, device, and/or the likes, which executes further processing on indications from the system. The output may be further used to indicate network status on other systems, the cloud, displayed on a web page through the internet, and/or the likes.

The processor 111 may be homogenous or heterogeneous and may include one or more processing nodes arranged for parallel processing, as clusters and/or as one or more multi-core processors. The storage medium 116 may include one or more non-transitory persistent storage devices, for example, a hard drive, a Flash array, a removable media, and/or the like. The storage medium 116 may also include one or more volatile devices, for example, a random access memory (RAM) component and/or the like. The storage medium 116 may further include one or more network storage resources, for example, a storage server, a network attached storage (NAS), a network drive, and/or the like, accessible via one or more networks through the input interface 112 and the output interface 115. Furthermore, faster access storage hardware such as dedicated registers, latches, caches, context addressable memory, and/or the likes may be used to enhance processing speed. Data that has to be accessed frequently such as parameters of the base sequence may be stored using faster access devices, such as caches or video random memory (VRAIVI), while data that is accessed rarely such as dictionaries associated with early bases may be stored using slower, yet more flexible and inexpensive means such as a network attached storage, a cloud service, and/or the like.

Referring now to FIG. 2, which is a flowchart of an exemplary process for network flow optimization using a simplex type algorithm, according to some embodiments of the present disclosure. The processor 111 may execute the exemplary process 200 for a variety of purposes involving network flow optimization, for computer networks, data communication systems, pipe networks, rail systems and/or the like. Alternatively, the process 200 or parts thereof may be executing using a remote system, an auxiliary system, and/or the like. The process 200 may be executed to optimize network flow by finding an optimal, or a near optimal solution, for a linear programming problem based on network variables. The problem variables, such as state variables, constraints, target variables and/or the like, may be received from the sensor 122 or the network 124, shown in FIG. 1, and may be associated with capacities, configurations, performance indexes, and/or the like of one or more network resources.

The exemplary process 200 starts, as shown in 201, with calculating an initial solution (θ=0). The initial solution is for a single, zero length, interval, and be obtained using simplex algorithm, crisscross algorithm, ellipsoidal algorithms, projective algorithms, variants thereof, and other linear programming algorithms, for the time zero. The solution may be referred to as tentative solution, as it may be optimal for zero, immediate, horizon. The processor may calculate or receive the initial solution.

The exemplary process 200 continues, as shown in 202, with calculating a storage limit for the dictionary set. Calculating a storage limit for the dictionary set is may be based on the numbers of the plurality of variables and the plurality of linearly time dependent constraints. One factor affecting the dictionary set size is the size of the memory allocated to the simplex dictionary. Another factor is the problem size. The size complexity of the single dictionary may be quadratic with respect to the number of variables, for example, the number of control variables plus the number of state variables plus one, multiplied by the number of constraints plus the number of target variables, plus one. Alternative implementations may apply compression on the dictionary, however dictionary encoding and decoding time should also be considered. An exemplary dictionary set size limit may be obtained by dividing the memory size, normalized for variable precision (e.g. 8,16,32,64,128 bits per variable, signed or unsigned, integer, floating point, or a functionally interchangeable representations), by the number of variables and the number of constraints and target factors. The number is the dictionary set size limit, according to which the processor executing the process may set, submit, and/or receive a threshold determining when to prune the dictionary set and remove dictionaries.

The exemplary process 200 continues, as shown in 203, with detecting the next collision. The processor executing the process may raise the value of 0, gradually extending the validity and optimality range of the tentative solution, and check at what value of 0, at least one variable reaches zero, a constraint is met tightly with zero slack, and/or the like, giving rise to a collision. The variable shrinking to zero may be a slack variable, indicating a constraint became tight, a quantity or state value that must be positive, an interval length, and/or the like. The collision may further occur when there is a plurality of different variables reaching zero simultaneously. The collision may indicate that the tentative solution, which may be valid and optimal for t<θ, may no longer be valid and/or optimal for t>θ.

The collision may impose changes on a single, two adjacent, or several separate bases, or linear segments of the base sequence, and may impose the changes at the middle, at the boundaries and/or anywhere along the sequence.

A new tentative solution, valid for t>θ, for to at least some extent, may be obtained by a pivot operation, such as SCLP pivot, MCLP pivot, and/or the like. The complexity of the pivot operation may depend on the collision type and affected locations.

In some collisions, a single interval length reaches zero, or length of sequence of consecutive intervals reaching zero. When the bases corresponding to these intervals is either at the boundary, i.e., the beginning or the end of the sequence, or the ratio between the neighboring bases is one, the collision may be considered a Type I collision.

When the collision is characterized by an interim interval length reaching zero or lengths of sequence of consecutive intervals reaching zero simultaneously, and the ratio between the neighboring bases is two, the collision may be considered a Type II collision.

When the collision is characterized by a local minima of a state variable reaching zero, the collision may be considered a Type III collision.

Further details about the collision taxonomy above and an exemplary algorithm to solve SCLP problems may be found in the publication titled “A Simplex Based Algorithm to Solve Separated Continuous Linear Programs”, by Gideon Weiss.

Alternative collision taxonomies for problems such as SCLP and MCLP may be applied. For example, When the collision is characterized by a local minima of a state variable reaching zero, or another threshold, the collision may be considered a Type A collision. When the collision is characterized by one or more consecutive interim interval lengths reaching zero, and the ratio between the neighboring bases is two, the collision may be considered a Type B collision. When the one or more bases whose intervals lengths reaches zero is either at the boundary, i.e. the beginning or the end of the sequence, or the ratio between the neighboring bases is one, the collision may be considered a Type C collision if all state variables that were set to zero in these bases are also set to zero in other places. When the one or more bases whose intervals lengths reaches zero is either at the boundary, i.e., the beginning or the end of the sequence, or the ratio between the neighboring bases is one, and the one or more variables were set to zero only at a bases whose lengths shrunk to zero, the collision may be considered a Type D collision. When the collision is characterized by a local minima of a state or impulse control variable reaching zero, and the local minima is on a boundary, the collision may be considered a Type E collision. When the collision is characterized by an interval at the boundary length reaching zero, and at least one state variable value at the boundary becomes zero, the collision may be considered a Type F collision.

Further details about the exemplary alternative collision taxonomy may be found in the publication titled “A simplex-type algorithm for continuous linear programs with constant coefficients” by Evgeny Shindin and Gideon Weiss.

The collision may be considered a single collision if it can be classified by the one of types described above. The single collision may be considered simple if either a strict local minimum shrinks to zero, or a single interval shrinks to zero but not both. When a strict local minimum shrinks to zero, and a single interval shrinks to zero, it may be considered a multiple collision. A single collision in which more than one interval shrinks to zero may be referred to as a compound single collision. A single collision may affect the joint boundary of validity regions of exactly two neighboring bases, or the boundary of the sequence. A multiple collision may be on the boundary of more than two validity regions. When the collisions are single but compound then it may be necessary to solve a sub-problem to perform the pivot operation.

It should be noted that combined collisions, wherein more than one collision occurs at the same time horizon, θ, may occur.

The exemplary process 200 continues, as shown in 204, with checking if the collision is within the domain, or the desired time horizon (i.e. θ<T).

When the collision happens beyond the desired time horizon, or θ>T, the process 200 may continue to conclusion as shown in 220.

When the collision happens within the desired time horizon, or θ<T, the processor or system executing the exemplary process 200 may continue by processing and resolving the collision, and generating a new tentative solution that may be valid and optimal for farther time horizons, as shown in 205.

The collision resolution for type I collision may comprise removing one or more bases, or linear segments from the tentative solution. When a base, or a linear segment of a function, is removed, some implementation may automatically prune the dictionary associated with it, and the corresponding simplex dictionary may be removed from dictionary set. The automatic pruning may occur either when dictionaries are organized in the set according to the location of the associated basis in the base sequence or not. Alternative implementation may map dictionaries to the solution space and store one or more dictionaries not associated with bases which are part of the tentative solution.

The collision resolution for type II collision may comprise adding one or more bases, or linear segments to the tentative solution. The collision resolution for type III collision may comprise both removing one or more bases, or linear segments from the tentative solution, and adding one or more bases, or linear segments to the tentative solution.

The exemplary process 200 continues, as shown in 206, with checking when the collision resolution requires adding one or more bases, i.e. a subsequence, to the base sequence. When the collision is type I, new bases may not be required for the base sequence, and the process may continue by repeating block 203, or raising the time horizon 0 until a new collision is encountered.

When the collision is type II or type III, the exemplary process 200 may continue with checking whether an adjacent base, or a linear segment, has a dictionary associated therewith, as shown in 207.

The collision resolution indicates one or more time intervals for the tentative solution, having linearly time dependent value function of variables and the linearly time dependent constraints on the variables determining a linear segment for the time interval.

The processor executing the process may search the dictionary set for one or more simplex dictionaries based on the proximity between the linear segment corresponding to the time interval and the linear segment corresponding to simplex dictionaries.

Alternatively, the process may check the solution space for a matching dictionary, or for a close solution, from which calculating the required dictionary requires the minimal number of pivots. It should be noted that calculating the new basis is a simple operation once an adjacent dictionary exists, requiring a single simplex pivot.

When an adjacent dictionary is not found, the exemplary process 200 may continue, as shown in 208, with calculating the dictionary. Calculating the dictionary based on an initial simplex table, or a non-adjacent dictionary, or a pivot such as MCLP or SCLP pivot, may require multiple simplex pivots. When an indirectly adjacent, or otherwise proximal dictionary is found, the number of simplex pivots required to execute the MCLP or the SCLP pivot may be smaller. Therefore, when the closest dictionary from the sequence for which a simplex dictionary is stored in the dictionary set mismatches the interval by one or more indexes, or by one or more pivots or vertices in the solution space, the processor executing the process may calculate a new simplex dictionary that matches the time interval by applying one or more simplex type pivots on the dictionary found.

The exemplary process 200 continues, as shown in 209, with adding the subsequence based on the dictionary.

When an adjacent dictionary is available, calculating the new basis and its associated dictionary may requires a single simplex pivot. When the dictionary from the dictionary set complies with the corresponding time interval, a simplex table stored therein may be used for calculation of the linear segment associated with the time interval. Optionally, the dictionary is stored in the dictionary set, arranged in accordance with the intervals or the linear segments associated with the intervals. Alternative implementations may store the dictionary only if it meets a distance criteria from other stored dictionary, for example, if the distance from the closest stored dictionary is at last three simplex pivots, bases, and/or the like. The new linear segments mat be added to the tentative solution either when the dictionary is stored or not, giving rise to an updated base sequence, that may be optimal for a farther time horizon.

The exemplary process 200 continues, as shown in 210, with checking when the storage limit for the dictionaries exceeded, or a threshold associated with the storage limit is met. When the storage limit is exceeded dictionaries have to be pruned, by removing one or more of the plurality of simplex dictionaries from the dictionary set. Not removing any dictionaries may result in exceeding the allocated memory, and may cause loss of data or system exceptions.

The exemplary process 200 continues, as shown in 215, with removing at least one dictionary from the dictionary set, while maintaining a neighbor density measure. This is required to be able to store dictionary set, allowing faster calculation of SCLP pivots, MCLP pivots, and/or the like without exceeding the allocate storage space.

When the storage limit is exceeded one or more of the plurality of simplex dictionaries from the dictionary set are removed. Dictionaries may be removed in accordance with the storage limit, or a threshold based thereon, while maintaining a neighbor density measure. The neighbor density measure may be based on a distance between the simplex dictionary to be removed and at least one non-removed simplex dictionary. The distance may be based on the distance between the bases associated with the dictionaries along the base sequence being the tentative solution. Alternatively, the distance may correspond to a number of simplex pivots required to construct the simplex dictionary from the at least one non-removed simplex dictionary, or the distance in the solution space.

The exemplary process 200 concludes, as shown in 220, with finalizing the base sequence for the desired time horizon 0 =T, rendering the tentative solution optimal. The processor executing the process may transmit one or more variables from the optimal solution to the network 124 and/or the display 125 shown in FIG. 1. One or more variables may be associated with one or more network resource and use for configuration or otherwise control thereof. For example, a variable may indicate if a relay is open, how open a tap is, pressure in a pipe used for transporting fluids, a railway junction state, controls of communication devices on a computer network such as configuration of routers or switches, mode of a processor on a computer network, a processing device such as GPU, priority for using a data bus, and/or the like.

Furthermore, one or more target variables, associated with a value function may be correlated to performance indexes of network resource and/or the network in general.

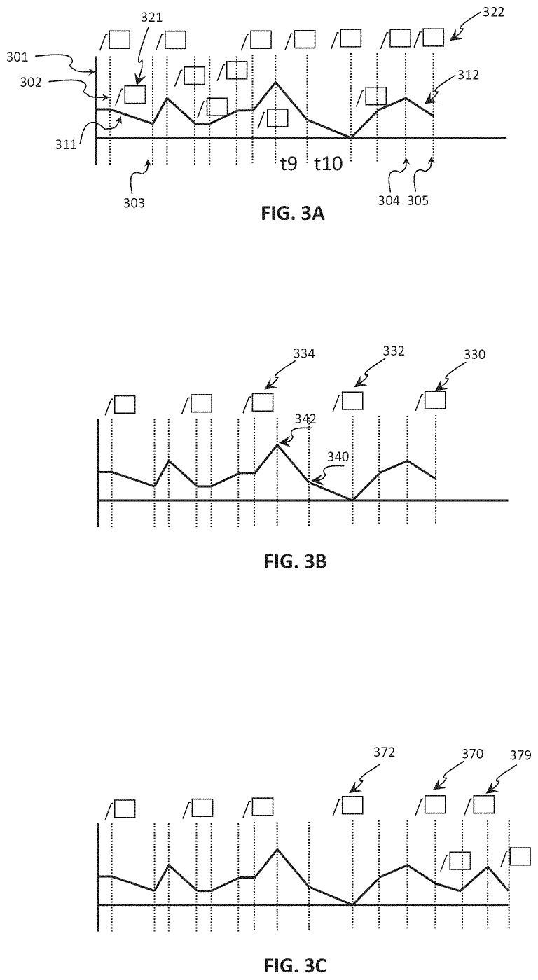

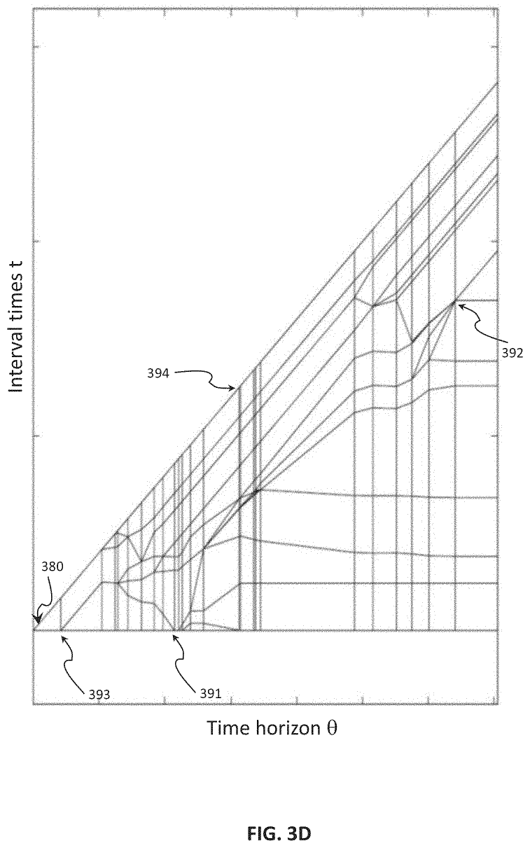

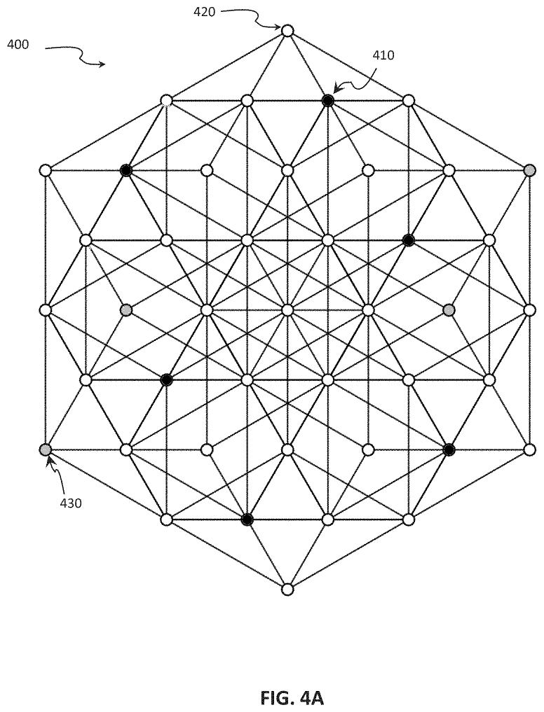

Reference is now made to FIG. 3A which depicts an exemplary base sequence with the corresponding dictionary set, before removing dictionaries in accordance with the storage limit, according to some embodiments of the present disclosure.

FIG. 3A depicts an exemplary base sequence, which is a tentative solution for a time dependent linear programming problem such as SCLP. The base sequence defines a piecewise linear function, each separated by a time cusp tᵢ. The intervals in which the function is linear may be numbered τᵢ. for example, the 10th segment τ₁₀ between t₉ and t₁₀. The first segment to starts at the initial, zero, time boundary, or the axis 301, at ends at the cusp of t₁ 302. The second segment 311 is between t₁ 302 and t₂ 303. Similarly, the 13th segment 312 i342s between t₁₂ 304 and t₁₃ 305.

Every basis defines a linear segment of the base sequence, for example, the second segment 311 and the last, 13th segment 312. Each segment has a dictionary associated with it, for example the second segment 311 has the associated dictionary 321, and the 13th segment 312 has the associated dictionary 322. A dictionary may comprise a simplex table, which may be stored in a straightforward array, as a sparse array, or encoded using compression methods such as Huffman coding, however compression may incur delays when recovering the dictionary. A dictionary may further comprise vectors, scalars, and additional properties. The basis may be straightforwardly derived for the simplex table, and neighboring dictionary may differ by one or more simplex pivots. Alternatively, the dictionary may comprise a partial representation of the simplex table, from which recovering other parts of the simplex table may require some calculations. It should be noted that compression techniques using special properties of simplex tables may be developed or used to reduce the dictionary size.

Reference is also made to FIG. 3B which depicts an exemplary base sequence with the corresponding dictionary set, after removing dictionaries in accordance with the storage limit, while maintaining a neighbor density measure, according to some embodiments of the present disclosure.

The exemplary base sequence, is the same sequence depicted in FIG. 3A, after the dictionary set pruning. The pruning of the dictionary set may comprise removing at least one of the plurality of simplex dictionaries from the dictionary set in order to comply with the storage limit, while maintaining a neighbor density measure. In the exemplary dictionary set depicted in FIG. 3B, in which the dictionaries are associated with the linear segments forming the base sequence, the neighbor density measure is based on a linear distance between linear segments in the base sequence.

When dictionaries may be kept even when there having no associated linear segment in the base sequence, they may be pruned when their removal is needed to comply with the storage limit.

Alternative density measures may be based on a distance between the dictionaries removed and a non-removed simplex dictionary, either the closest or a one or more other dictionaries, wherein the distance corresponds to a number of simplex pivots required to construct the dictionaries removed from the at least one non-removed dictionary, or another measure based on the solution space.

In this example every third dictionary was kept, in accordance with the order of the associated base in the base sequence, i.e. the 1st, the 4th, the 7th 334, the 10th 332, and the 13th 330. The kept dictionaries may be distributed evenly, or biased toward areas where collisions are more likely, for example the boundaries, or the end. Alternative density conservation may be applied by other heuristics, for example, storing number of changes per segment clusters, or when certain properties of the network may be used to enhance predicting which segments are more mutable.

Dictionaries stored may be used when a new linear segment is to be added. For example, when the new linear segment is to be added between the 9th and 10th segment at 340, the dictionary associated with the 10th segment 332 may be used.

When the new linear segment is to be added between the 8th and 9th segment at 342, the dictionary associated with the 10th segment 332 may be still be used, however it may require one or more simplex pivots, to recover the dictionary associated with the 9th segment, from which generating the new linear segment may be executed directly.

Alternatively, the dictionary associated with the 7th segment 334 may be still be used, applying one or more simplex pivots, to recover the dictionary associated with the 8th segment, from which generating the new linear segment may also be executed directly.

Alternative implementation may follow the assumption that random pruning may approximate even distribution and select one or more dictionary to remove randomly.

Other dictionaries, from which multiple simplex pivots may be required, may also be used at the expense of executing additional simplex pivots.

Reference is now made to FIG. 3C which depicts an exemplary base sequence with the corresponding dictionary set, after removing dictionaries in accordance with the storage limit, while maintaining a neighbor density measure, according to some embodiments of the present disclosure.

Following the pruning of the dictionary set as shown on FIG. 3B, the processor calculating the solution may continue and calculate the solution for farther time horizons, which may comprise adding new linear segments to the tentative solution.

When a new linear segment, or a basis is added to the base sequence, the processor calculating the solution may store one or more of the simplex dictionaries, associated with the new bases, in the dictionary set.

The storing may be conditional, depending on neighborhood density, for example, only if the basis has no immediate neighbor with an associated dictionary in the dictionary set. Unconditional storage of the dictionaries associated with the new bases, or other conditions may be apply according to neighborhood density, heuristics and the like.

The simplex dictionaries added to the dictionary set may be the corresponding simplex dictionaries of one or more linear function being added to the sequence of linear functions, or the base sequence.

In the exemplary sequence depicted in FIG. 3C, the new bases are added at the end boundary of the sequence. The dictionaries of the earlier linear segments, for example the dictionary associated with the 10th segment 372 and the dictionary associated with the 13th segment 370 may be unchanged, and new dictionaries are added for the new segment, for example the dictionary associated with the 15th segment 379.

Reference is now made to FIG. 3D which depicts an exemplary base sequence interval progression, as time horizon is extended, according to some embodiments of the present disclosure.

The process, such as 200 as shown in FIG. 2, starts with an initial solution, for the time horizon θ=0, as shown in 380, wherein there is a single, zero length, interval. The process solving the exemplary problem may encounter a Type III, collision, 393, where a new interval is added. The process may continue, adding and removing intervals while the time horizon is extended. An exemplary Type I collision, 391, shows an interval length reaching zero. Another exemplary collision 394 is a multiple collision, wherein more than one interval length reaches zero. One interval being removed at the beginning, and an interval in the middle being replaced. An exemplary type II collision 392, shows a sub-sequence of some intervals reaches zero length, and replaced by a new interval. The collision 392 is the last collision before the exemplary sequence reaches the time horizon θ=T, and one or more variables based on the based sequence may be used to control the associated network.

This exemplary interval sequence progression is shown for the purpose of better understanding the exemplary collision taxonomy, wherein the resolution of Type II and Type III collisions may require use of a simplex dictionary for faster resolution, for reduced consumption of time and computation resources. It is an interval sequence progression for a specific problem and other problems may generate different sequence progressions.

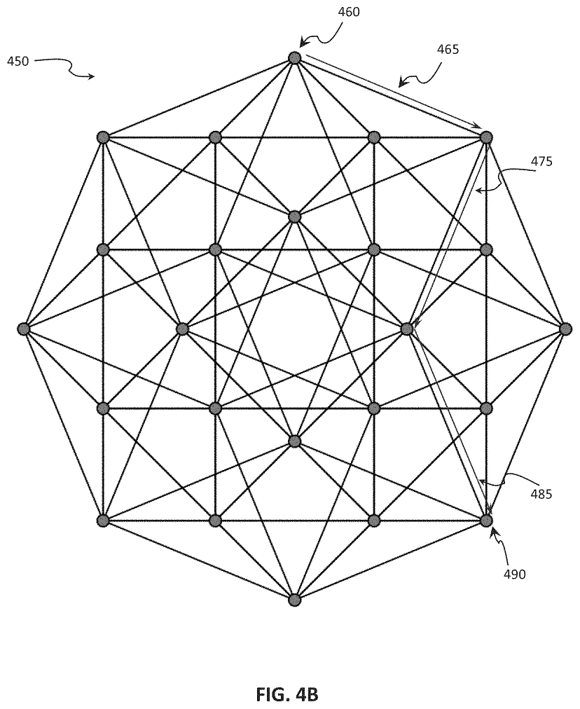

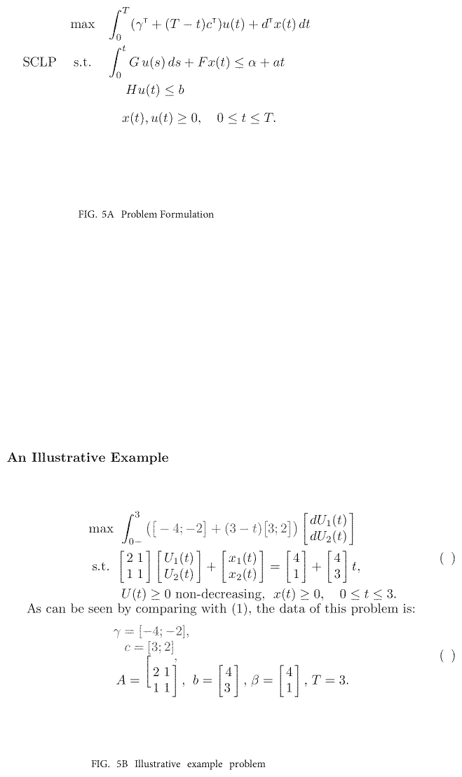

Reference is now made to FIG. 4A which depicts an exemplary solution space, based on a truncated simplex and having a dictionary set associated with, projected to two dimensions, according to some embodiments of the present disclosure.

FIG. 4A depicts the two dimensional projection of an exemplary solution space 400, wherein edges are shown as lines and vertices as circles. Note that the solution space is not necessarily symmetrical, however given the constraints are linear, the solution space may be viewed a convex polytope.

Vertices having an associated dictionary such as 410 are be marked by a black circle. Vertices adjacent to at least one vertex having an associated dictionary such as 420 are be marked by a white circle. Other vertices such as 430 are marked by a grey circle.

This example provides an alternative view of the solution space and the potential dictionary space, enabling some exemplary alternative implementations of a dictionary set in a simplex type algorithm context. In this example a new base may be added in adjacency to a segment, associated with the solution space vertex 420. The vertex 420 may not have an associated dictionary stored, however an adjacent vertex 410 may have one, and reconstructing the dictionary associated with the vertex 420 from a dictionary associated with an adjacent vertex may require a single simplex pivot.

When a new base is added in adjacency to a segment associated with a vertex such as 430, more calculations, such as multiple simplex pivots may be required, however the segment to be added may have another neighbor, which may have a neighbor with an associated dictionary, which may enable recovering the dictionary by a single simplex pivot.

Reference is also made to FIG. 4B which depicts an exemplary sequence of simplex pivots over a solution space, based on a truncated simplex, projected to two dimensions, according to some embodiments of the present disclosure.

This example provides an alternative view of the solution space, provide for the purposes of better understanding the solution space, and alternative implementations of a dictionary set in a simplex type algorithm context. The exemplary sequence of simplex pivots may be executed as a part of a pivot such as SCLP or MCLP pivot, and be associate with a base sequence, a sub-sequence and/or the likes. The exemplary sequence of simplex pivots is shown over an exemplary solution space 450, projected to two dimensions, wherein edges are shown as lines and vertices as circles. Note that the solution space is not necessarily symmetrical, however given the constraints are linear, the solution space may be viewed a convex polytope.

The sequence starts at an initial vertex of the solution space 460, and continues through three pivots, the first 465, the second 475, and the third 485, to the latter, target vertex of the solution space 480.

The sequence may depict how a base sequence or a sub-sequence may appear in the solution space, and how a complex pivot operation may appear in terms of simplex pivots over the solution space.

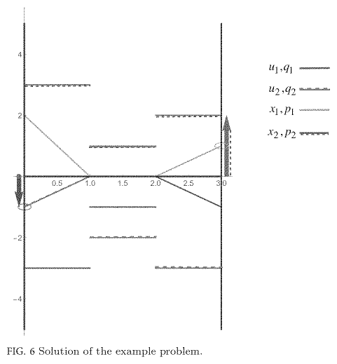

Reference is now made to FIG. 5A which is an exemplary formulation of separated continuous linear programming (SCLP) problems, according to some embodiments of the present disclosure.

The problem refers to optimizing maximizing a value function while complying to constraints, wherein G, H, and F are fixed matrices, a, a, y, c, b, and d are fixed vectors, and the unknowns are bounded measurable controls u(t), and absolutely continuous states x(t). A symmetric dual problem has been formulated, and other variants such as MCLP may be solved by similar means. Simplex type algorithm may solves these problems in a finite bounded number of steps. The first row may be referred to as a target or a value function, and the second row as the constraints or constraint equation.

The continuous states may represent a variety of network states such as temperature, speed, queue length, buffer occupancy, fluid pressure, and/or the like, and the controls may be configurations such as routing policies, relays, and/or the like.

Reference is also made to FIG. 5B which is a formulation of an exemplary measure-based continuous linear programming (MCLP) problem, according to some embodiments of the present disclosure.

Note that the variables are shown as differentials in the target integral, and the constraint as a function and not an integral, and the solution may comprise deltas, or bursts. The matrices, vectors, and scalars are the constraints and target parameters of a simple, exemplary MCLP problem. The parameters may be received from the network, a sensor device, a computer readable media, and/or the like. The constraint parameters may be formulated based on network parameters, and the target parameters may be based on performance indexes, related to one or more timed contracts the time horizon is associated with.

Reference is now made to FIG. 6 which is a solution of the exemplary measure-based continuous linear programming (MCLP) problem, formulated on FIG. 5B, according to some embodiments of the present disclosure.

The solution is shown also in the symmetric dual form, with bounded measurable controls p(t) and states q(t). Also note that the solution comprises deltas at the initial time 0, as well as the end, or horizon time 3. It should be emphasized that the problem is a simple, exemplary, problem, and networks may comprise several orders of magnitude larger numbers of control variables, state variables, target variables, constraints, and/or the like.

Reference is now made to FIG. 7 which is an exemplary code for optimizing a network flow, using a simplex type algorithm, without using simplex dictionaries, according to some embodiments of the present disclosure.

The exemplary simplex type algorithm, without using simplex dictionaries, starts with calculating the initial solution, i.e. for θ=0. It than iteratively finds the next value of 0 giving rise to a collision. When the value of 0 is within the horizon (1 in this example), the collision may be handled according to its type.

When the collision is type I, it may be resolved by removing one or more linear segments from the tentative solution.

When the collision is of type II or type III, a Rates-LP problem has to be solved to obtain one or more segments to be added to the tentative solution. This may, in particular when Rates-LP generates a new basis not adjacent to the collision require solving the SCLP sub-problem for the sub-sequence, require multiple simplex pivots, and be time consuming.

Type II collisions resolution may comprise replacing bases by the sub-sequence, whereas type III collision resolution may comprise adding the sub-sequence.

When θ0 reaches the horizon the tentative solution is finalized and the function returns it.

Reference is now made to FIG. 8 which is an exemplary code for optimizing a network flow, using a simplex type algorithm, using simplex dictionaries, according to some embodiments of the present disclosure.

The exemplary simplex type algorithm, having a dictionary set, checks how much free memory is available and how many variables characterize the problem and decides what is the maximum number of simplex dictionaries that can be stored. New dictionaries stored may be stored up to this number, or a somewhat lower number based thereupon. Attached to the simplex dictionaries, the algorithm may store keys, or names of the primal and dual basic variables for this dictionary. The algorithm may further store a sequence of pivots starting from first basis of the base sequence and up to last basis in the base sequence. The sequence of pivots may contains identifiers of variables, leaving and entering tightness for each pivot. When the number of simplex dictionaries reached the threshold or the maximum number, the algorithm may remove one or more dictionaries at each, in one or more iterations, keep equal or similar distance between dictionaries in the base sequence. When a type II or type III collision occurs algorithm looks up the stored dictionary set, takes the dictionary with minimal distance to adjacent segments, and may perform a sequence of pivots to obtain dictionaries for one or more new segments and/or interim segments. The sequence of pivots may utilize stored information on leaving and entering variable names that enable recovering one simplex dictionary another simplex dictionary without full rates calculation and comparison. When bases in the base sequence are removed or replaced sequence of pivots are updated. The simplex dictionaries associated with the removed or replaced bases may be removed. The algorithm may check that at least one simplex dictionary always present in a base sequence. If simplex dictionary set is empty the algorithm may calculate a simplex dictionary for a boundary basis, a basis adjacent to the most recent collision, or a random basis and store it.

Rows other than 3,13,14,15,18,19 and 31 are the same as in the code without using simplex dictionaries, shown in FIG. 7.

The simplex type algorithm, using simplex dictionaries, starts similarly to the algorithm without using simplex dictionaries by calculating an initial solution, however it further comprises calculating the number of dictionaries, according to the free memory size allocated, the number of variables and a constant of some keys, mappings, and the like. The algorithm may further store a dictionary associated with the initial solution.

It also iteratively finds the next value of 0 giving rise to a collision. When the value of 0 is within the horizon (1 in this example), the collision may be handled according to its type.

When the collision is type I, it may be resolved by removing one or more linear segments from the tentative solution. However, it may further comprise removing the dictionaries associated with the linear segments removed.

When the collision is of type II or type III, the algorithm, using simplex dictionaries first tries to generate the new basis to be added using an adjacent dictionary. If it fails to find a dictionary within adequate proximity, it may continue similarly to the algorithm without using simplex dictionaries.

The algorithm further comprises pruning the dictionaries when removal of extra dictionaries is required to comply with a threshold or the storage limit.

It is expected that during the life of a patent maturing from this application many relevant linear programming algorithms, compression techniques, and computation technologies for storage and processing will be developed and the scope of the problems that may be solved using simplex type algorithms, and the solution methods is intended to include all such new technologies a priori.

The terms “comprises”, “comprising”, “includes”, “including”, “having” and their conjugates mean “including but not limited to”.

As used herein, the singular form “a”, “an” and “the” include plural references unless the context clearly dictates otherwise. For example, the term “a variable” or “at least one variable” may include a plurality of variables, including combinations thereof. Throughout this application, various embodiments of this invention may be presented in a range format. It should be understood that use of words such as several, as well as the description in range format, are merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

In addition, citation or identification of any reference in this application shall not be construed as an admission that such reference is available as prior art to the present invention. To the extent that section headings are used, they should not be construed as necessarily limiting.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for generating optimal control policy for controlling network resource allocation, comprising:
one or more computer processors, one or more computer readable storage media, and program instructions collectively stored on the one or more computer readable storage media for execution by at least one of the one or more computer processors, the program instructions comprising:
program instructions to store a dictionary set, comprising simplex dictionaries, for saving processing time when calculating an optimal control policy for at least one linearly time dependent value function of a plurality of variables complying with a plurality of linearly time dependent constraints;
program instructions to calculate a storage limit for the dictionary set, based on a number of the plurality of variables, the plurality of constraints, and size of a memory; and
program instructions to remove at least one of the plurality of simplex dictionaries from the dictionary set in accordance with the storage limit, while maintaining a neighbor density measure, wherein:
the neighbor density measure is based on a distance between the at least one of the plurality of simplex dictionaries and at least one non-removed simplex dictionary; and
the distance corresponds to a number of simplex pivots required to construct the at least one of the plurality of simplex dictionaries from the at least one non-removed simplex dictionary.

2. The system of claim 1, wherein the memory further stores a sequence of linear segments, and the neighbor density measure is based on a linear distance between linear segments in the sequence.

3. The system of claim 2, further comprising:
program instructions, collectively stored on the one or more computer readable storage media for execution by at least one of the one or more computer processors, to receive a time interval for the at least one linearly time dependent value function of a plurality of variables and the plurality of linearly time dependent constraints on the plurality of variables determining a linear segment for the time interval; and
program instructions, collectively stored on the one or more computer readable storage media for execution by at least one of the one or more computer processors, to search the dictionary set for at least one simplex dictionary based on the proximity between at least one of the linear segments corresponding to the time interval and the linear segment corresponding to simplex dictionary.

4. The system of claim 3, further comprising:
program instruction, collectively stored on the one or more computer readable storage media for execution by at least one of the one or more computer processors, to, responsive to the at least one simplex dictionary complying with the corresponding time interval, use the at least one simplex dictionary for calculation of at least one linear segment associated with the time interval.

5. The system of claim 3, further comprising:
program instructions, collectively stored on the one or more computer readable storage media for execution by at least one of the one or more computer processors, to responsive to the at least one simplex dictionary mismatching the time interval by at least one index, calculate a new simplex dictionary that matches the time interval by applying at least one simplex type pivot on the at least one dictionary.

6. The system of claim 4, further comprising:
program instructions, collectively stored on the one or more computer readable storage media for execution by at least one of the one or more computer processors, to allocate at least one network resource in accordance with the sequence of linear segments for at least one variable from the plurality of variables, wherein the at least one variable is associated with the at least one network resource.

7. The system of claim 1, wherein at least one variable from the plurality of variables is associated with at least one network resource, and the at least one linearly time dependent value function is correlated to at least one performance index of the at least one network resource.

8. The system of claim 7, wherein the at least one network resource comprises a pipe used for transporting at least one fluid.

9. The system of claim 7, wherein the at least one network resource comprises at least one communication device on a computer network.

10. The system of claim 7, wherein the at least one network resource comprises at least one processor on a computer network.

11. The system of claim 1, wherein the at least one of the plurality of simplex dictionaries in the dictionary set is derived from a simplex type algorithm.

12. The system of claim 1 wherein program instructions to calculate a storage limit for the dictionary set is based on the numbers of the plurality of variables and the plurality of linearly time dependent constraints.

13. The system of claim 1 wherein the at least one simplex dictionary is the corresponding simplex dictionary of a linear segment being added to the sequence of linear segments.

14. The system of claim 1, further comprising:
program instructions, collectively stored on the one or more computer readable storage media for execution by at least one of the one or more computer processors, to responsive to a linear segment being removed from the sequence of linear segments, remove the corresponding simplex dictionary from dictionary set.

15. A computer implemented method for generating optimal control policy for controlling network resource allocation, comprising:
storing a dictionary set, comprising simplex dictionaries, for saving processing time when calculating an optimal control policy for at least one linearly time dependent value function of a plurality of variables complying with a plurality of linearly time dependent constraints
calculating a storage limit for the dictionary set, based on a number of the plurality of variables, the plurality of constraints, and size of a memory; and
removing at least one of the plurality of simplex dictionaries from the dictionary set in accordance with the storage limit, while maintaining a neighbor density measure, wherein:
the neighbor density measure is based on a distance between the at least one of the plurality of simplex dictionaries and at least one non-removed simplex dictionary; and
the distance corresponds to a number of simplex pivots required to construct the at least one of the plurality of simplex dictionaries from the at least one non-removed simplex dictionary.

16. The computer implemented method of claim 15, wherein the memory further stores a sequence of linear segments, and the neighbor density measure is based on a linear distance between linear segments in the sequence.

17. The computer implemented method of claim 16, further comprising:
receiving a time interval for the at least one linearly time dependent value function of a plurality of variables and the plurality of linearly time dependent constraints on the plurality of variables determining a linear segment for the time interval; and
searching the dictionary set for at least one simplex dictionary based on the proximity between at least one of the linear segments corresponding to the time interval and the linear segment corresponding to simplex dictionary.

18. The computer implemented method of claim 17, further comprising:
responsive to the at least one simplex dictionary complying with the corresponding time interval, using the at least one simplex dictionary for calculation of at least one linear segment associated with the time interval.

19. The computer implemented method of claim 17, further comprising:
responsive to the at least one simplex dictionary mismatching the time interval by at least one index, calculating a new simplex dictionary that matches the time interval by applying at least one simplex type pivot on the at least one dictionary.

20. The computer implemented method of claim 18, further comprising:
allocating at least one network resource in accordance with the sequence of linear segments for at least one variable from the plurality of variables, wherein the at least one variable is associated with the at least one network resource.

21. The computer implemented method of claim 15, wherein at least one variable from the plurality of variables is associated with at least one network resource, and the at least one linearly time dependent value function is correlated to at least one performance index of the at least one network resource.

22. The computer implemented method of claim 21, wherein the at least one network resource comprises a pipe used for transporting at least one fluid.

23. The computer implemented method of claim 21, wherein the at least one network resource comprises at least one communication device on a computer network.

24. The computer implemented method of claim 21, wherein the at least one network resource comprises at least one processor on a computer network.

25. A computer program product for generating optimal control policy for controlling network resource allocation, comprising:
one or more computer readable storage media, and program instructions collectively stored on the one or more computer readable storage media, the program instructions comprising:
program instructions to store a dictionary set, comprising simplex dictionaries, for saving processing time when calculating an optimal control policy for at least one linearly time dependent value function of a plurality of variables complying with a plurality of linearly time dependent constraints;
program instructions to calculate a storage limit for the dictionary set, based on a number of the plurality of variables, the plurality of constraints, and size of a memory; and
program instructions to remove at least one of the plurality of simplex dictionaries from the dictionary set in accordance with the storage limit, while maintaining a neighbor density measure, wherein:
the neighbor density measure is based on a distance between the at least one of the plurality of simplex dictionaries and at least one non-removed simplex dictionary; and
the distance corresponds to a number of simplex pivots required to construct the at least one of the plurality of simplex dictionaries from the at least one non-removed simplex dictionary.
